(19) United States
(12) Patent Application Publication
(10) Pub. No.: US 2026/0320616 A1
(43) Pub. Date: Oct. 15, 2026

(54) TRANSACTION SECURITY SYSTEM AND METHOD OF MANAGING CLOUD-BASED FINANCIAL TRANSACTIONS WITHIN A CLOUD COMPUTING ENVIRONMENT

(71) Applicant: ANKUR HARENDRASINH MAHIDA, JERSEY CITY, NJ (US)

(72) Inventor: ANKUR HARENDRASINH MAHIDA, JERSEY CITY, NJ (US)

(21) Appl. No.: 19/444,256

(22) Filed: Jan. 9, 2026

(51) Int. Cl. G06Q 20/40; G06Q 20/38

(52) U.S. Cl. CPC G06Q 20/4016; G06Q 20/382

(57) ABSTRACT

A method (300a-300b) of managing cloud-based financial transactions executed by a transaction security system (102) within a cloud computing environment is disclosed. The method includes receiving, by a transaction security engine (108) operating within a cloud computing environment, a financial transaction request associated with one or more computing nodes. The method includes generating a transaction-specific trust profile. The method includes establishing a zero-trust security context based on the generated transaction-specific trust profile. The method includes extracting a plurality of fraud-relevant features. The method includes generating a fraud likelihood score indicative of a probability of fraudulent activity. The method includes determining a transaction risk state indicating a real-time security posture of the financial transaction request. The method includes selecting one or more mitigation actions from a plurality of security actions. The method includes updating one or more policy parameters based on the selected one or more mitigation actions.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates generally to field of cloud computing and digital transaction systems. More particularly, to systems and methods for managing cloud-based financial transactions within a cloud environment.

### BACKGROUND OF THE INVENTION

Cloud computing environments are increasingly used to host financial platforms that process a large volume of digital transaction requests originating from distributed computing nodes, client devices, and networked services. Such cloud-based financial transaction processing typically involves interconnected components, including user interfaces, application services, payment gateways, authorization services, and backend data stores operating across shared or distributed infrastructure.

Conventional transaction processing architectures often rely on static trust assumptions, predefined access rules, or perimeter-based security models. Entities operating within a network boundary are treated as trusted once authenticated. The aforementioned approaches are not sufficiently account for dynamic variations in transaction context, device attributes, network conditions, or interaction patterns that occur during execution of financial transactions in cloud environments.

Existing fraud detection mechanisms frequently operate as isolated analytical components that generate risk indicators or alerts based on predefined rules or trained models. In many implementations, such mechanisms function independently of transaction execution logic and policy management components, resulting in limited coordination between risk evaluation, trust assessment, and action selection during transaction processing.

Further, policy management techniques used in cloud-based transaction systems are commonly static or manually configured, with limited capability to incorporate observed transaction execution outcomes into subsequent policy adjustments. As a result, transaction processing decisions are not reflecting evolving patterns of transaction behavior or system-level operational states across successive transaction requests.

Therefore, there is need to develop a system and method to overcome aforementioned problems.

### SUMMARY OF THE INVENTION

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a method of managing cloud-based financial transactions executed by a transaction security system within a cloud computing environment is disclosed. The method includes receiving, by a transaction security engine operating within a cloud computing environment, a financial transaction request associated with one or more computing nodes. The method includes generating, by the transaction security engine, a transaction-specific trust profile based on the received financial transaction request. The method includes establishing, by the transaction security engine, a zero-trust security context based on the generated transaction-specific trust profile. The method includes extracting, by the transaction security engine, a plurality of fraud-relevant features from the financial transaction request and the zero-trust security context. The method includes generating, by the transaction security engine, a fraud likelihood score indicative of a probability of fraudulent activity associated with the financial transaction request. The method includes determining, a transaction risk state indicating a real-time security posture of the financial transaction request within the cloud computing environment based on the generated fraud likelihood score and the transaction-specific trust profile. The method includes selecting, by the transaction security engine, one or more mitigation actions from a plurality of security actions based on the determined transaction risk state. The method includes updating, by the transaction security engine, one or more policy parameters based on the selected one or more mitigation actions to improve subsequent threat mitigation decisions for the cloud-based financial transactions.

In accordance with another embodiment of the present disclosure, a transaction security system for managing cloud-based financial transactions within a cloud computing environment is disclosed. The transaction security system includes a memory and at least one processor is operatively coupled to the memory. The at least one processor is configured to receive, using a transaction security engine operating within a cloud computing environment, a financial transaction request associated with one or more computing nodes. The at least one processor is configured to generate, using the transaction security engine, a transaction-specific trust profile based on the received financial transaction request. The at least one processor is configured to establish, using the transaction security engine, a zero-trust security context based on the generated transaction-specific trust profile. The at least one processor is configured to extract, using the transaction security engine, a plurality of fraud-relevant features from the financial transaction request and the zero-trust security context. The at least one processor is configured to generate, using the transaction security engine, a fraud likelihood score indicative of a probability of fraudulent activity associated with the financial transaction request. The at least one processor is configured to determine, a transaction risk state indicating a real-time security posture of the financial transaction request within the cloud computing environment based on the generated fraud likelihood score and the transaction-specific trust profile. The at least one processor is configured to select, by the transaction security engine, one or more mitigation actions from a plurality of security actions based on the determined transaction risk state. The at least one processor is configured to update, by the transaction security engine, one or more policy parameters based on the selected one or more mitigation actions to improve subsequent threat mitigation decisions for the cloud-based financial transactions.

In accordance with another embodiment of the present disclosure, a non-transitory computer-readable medium storing instructions that, when executed, cause at least one processor to receive, using a transaction security engine operating within a cloud computing environment, a financial transaction request associated with one or more computing nodes. The at least one processor is configured to generate, using the transaction security engine, a transaction-specific trust profile based on the received financial transaction request. The at least one processor is configured to establish, using the transaction security engine, a zero-trust security context based on the generated transaction-specific trust profile. The at least one processor is configured to extract, using the transaction security engine, a plurality of fraud-relevant features from the financial transaction request and the zero-trust security context. The at least one processor is configured to generate, using the transaction security engine, a fraud likelihood score indicative of a probability of fraudulent activity associated with the financial transaction request. The at least one processor is configured to determine, a transaction risk state indicating a real-time security posture of the financial transaction request within the cloud computing environment based on the generated fraud likelihood score and the transaction-specific trust profile. The at least one processor is configured to select, by the transaction security engine, one or more mitigation actions from a plurality of security actions based on the determined transaction risk state. The at least one processor is configured to update, by the transaction security engine, one or more policy parameters based on the selected one or more mitigation actions to improve subsequent threat mitigation decisions for the cloud-based financial transactions.

One or more advantages of the prior art are overcome, and additional advantages are provided through the invention. Additional features are realized through the technique of the invention. Other embodiments and aspects of the disclosure are described in detail herein and are considered a part of the invention.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a block diagram depicting an environment for establishing a transaction security system for managing cloud-based financial transactions within a cloud computing environment, in accordance with an embodiment of the present disclosure;

FIG. 2 illustrates a block diagram depicting the transaction security engine for managing the cloud-based financial transactions within the cloud computing environment, in accordance with an embodiment of the present disclosure; and

FIG. 3A-FIG. 3B illustrates a flowchart depicting a method for managing cloud-based financial transactions executed by a transaction security system within a cloud computing environment, in accordance with an embodiment of the present disclosure.

Skilled artisans will appreciate the elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

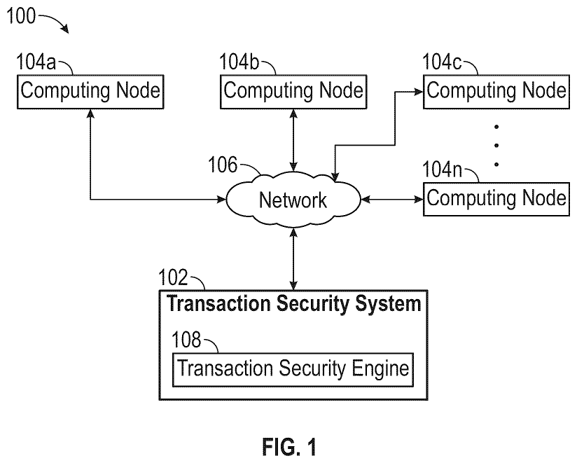

An environment and processes may be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the environment will be described in greater detail. The environment provides power of deep learning neural networks for data classification and clustering.

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 illustrates a block diagram depicting an environment 100 for establishing a transaction security system 102 for managing cloud-based financial transactions within a cloud computing environment, in accordance with an embodiment of the present disclosure. The environment 100 may include one or more computing nodes 104a, 104b, 104c . . . 104n and the transaction security system 102. The one or more computing nodes 104b, 104c . . . 104n may include, but are not limited to, one or more user entities, one or more client devices, and one or more cloud-hosted financial services, and the like.

In an embodiment, one or more computing nodes 104a, 104b, 104c . . . 104n may be communicated through a network 106. The network 106 may include an internet. The network 106 may be rapidly emerging as a preferred system for distributing and exchanging data. The network 106 may include a cellular network, a public land mobile network (PLMN), a second generation (2G) network, a third generation (3G) network, a fourth generation (4G) network (e.g., a long-term evolution (LTE) network), a fifth generation (5G) network, and/or another network. Additionally, or alternatively, the network 106 may include a wide area network (WAN), a metropolitan network (MAN), a telephone network (e.g., the Public Switched Telephone Network (PSTN)), an ad hoc network, an intranet, an Internet, a fiber optic-based network, and/or a combination of these or other types of networks.

In an embodiment, the transaction security system 102 may be established within the transaction security system 102 may be externally connected to the one or more computing nodes 104a, 104b, 104c . . . 104n. In another embodiment, the transaction security system 102 may be implemented within the one or more computing nodes 104a, 104b, 104c . . . 104n. Yet, in another embodiment, some part of the transaction security system 102 may be implemented within the one or more computing nodes 104a, 104b, 104c . . . 104n and remaining part of the transaction security system 102 may be externally connected to the one or more computing nodes 104a, 104b, 104c . . . 104n.

In an embodiment, the transaction security system 102 may include a transaction security engine 108. The transaction security engine 108 may be a cloud-resident processing component and operate as a logical and functional module executed on the one or more computing nodes 104a, 104b, 104c . . . 104n.

In an embodiment, the transaction security engine 108 may be configured to receive a financial transaction request associated with the one or more computing nodes 104a, 104b, 104c . . . 104n. The financial transaction request may include, but is not limited to, a transaction identifier, a transaction type indicator corresponding to a financial operation, transaction amount and currency data, identifiers associated with a source account, destination account, or financial instrument, user entity identifiers, client device identifiers, session identifiers, and request timestamp information. The financial transaction request may serve as a primary input.

In an example scenario, a user initiates a funds transfer operation using a client application executing on the one or more computing nodes 104a, 104b, 104c . . . 104n. The client application generates the financial transaction request corresponding to the funds transfer operation and transmits the request to a cloud-hosted financial service.

Upon receipt of the financial transaction request, the transaction security engine 108 may be configured to generate a transaction-specific trust profile based on contents of the request and establishes a zero-trust security context for the transaction. The transaction-specific trust profile may include a structured set of trust attributes including the one or more device integrity parameters, the one or more cryptographic session properties, the one or more network path characteristics, and the one or more historical access consistency metrics associated with the financial transaction request.

Further, the transaction security engine 108 may be configured to establish a zero-trust security context based on the generated transaction-specific trust profile. The zero-trust security context may include a set of access control parameters, one or more cryptographic validation states, one or more continuous verification rules applied to the financial transaction request.

The set of access control parameters may include one or more machine-readable control values associated with the financial transaction request that define permissible actions, resource access scopes, and execution constraints applicable to the transaction. The set of access control parameters is generated or selected by the transaction security engine 108 based on the transaction-specific trust profile and the zero-trust security context.

The one or more cryptographic validation states may include machine-readable indicators representing verification statuses of cryptographic elements associated with the financial transaction request. The cryptographic validation states may be determined by the transaction security engine 108 by evaluating cryptographic credentials or artifacts associated with the transaction.

The one or more cryptographic validation states may include, but are not limited to, a signature verification state associated with a digitally signed transaction request, a token integrity verification state corresponding to an authentication or authorization token, a key validity state indicating a status of a cryptographic key used for the transaction, and an encryption session state associated with a secure communication channel.

The one or more continuous verification rules may include machine-executable rule definitions applied by the transaction security engine 108 to the financial transaction request during one or more stages of transaction processing. The continuous verification rules are evaluated repeatedly or conditionally as transaction context data changes over time. The one or more continuous verification rules may include, but are not limited to, rules for validating consistency between transaction parameters and access control parameters, rules for re-evaluating cryptographic validation states upon context changes, rules for monitoring session or device attribute changes during transaction execution, rules for triggering reassessment of the transaction risk state based on detected state transitions. The one or more continuous verification rules may be applied throughout processing of the financial transaction request until transaction completion or termination.

In an example scenario, the financial transaction request corresponding to an online payment is received by the transaction security engine 108 from the client application executing on the one or more computing nodes 104a, 104b, 104c . . . 104n. The transaction-specific trust profile is associated with the financial transaction request and is used by the transaction security engine 108 to establish the zero-trust security context. Fraud-relevant features are extracted using the financial transaction request and the transaction-specific trust profile. The transaction-specific trust profile remains valid only for the duration of processing of the online payment transaction and is invalidated upon completion of the transaction processing.

In an embodiment, the transaction security engine 108 may be configured to extract a plurality of fraud-relevant features from the financial transaction request and the zero-trust security context. The plurality of fraud-relevant features may include, but is not limited to, a plurality of behavioral deviation indicators, a plurality of contextual risk indicators, a plurality of historical transaction correlations, a plurality of environmental anomaly signals, and the like.

In an embodiment, the transaction security engine 108 may be configured to generate a fraud likelihood score indicative of a probability of fraudulent activity associated with the financial transaction request. The fraud likelihood score may be expressed as a numerical value within a predefined range, a normalized score mapped to discrete probability intervals, or a categorical indicator corresponding to predefined probability levels.

The fraud likelihood score may be generated for each financial transaction request independently and is not persisted as a long-term user or device attribute. The fraud likelihood score may be provided as an input to a transaction risk state determination process executed by the transaction security engine 108. The fraud likelihood score may be expressed as a numerical value within a predefined range, a normalized score mapped to discrete probability intervals, or a categorical indicator corresponding to predefined probability levels.

In an example scenario, the financial transaction request corresponding to the digital payment is received by the transaction security engine 108 from the client application executing on the one or more computing nodes 104a, 104b, 104c . . . 104n. The transaction security engine 108 extracts fraud-relevant features from the transaction request, including a transaction amount, a transaction type indicator, device identifier data, session attributes, and network context information.

The transaction security engine 108 processes the extracted fraud-relevant features using a fraud-detecting model to generate the fraud likelihood score for the transaction request. In this example, the fraud likelihood score is represented as a numerical value within a predefined probability range. The generated fraud likelihood score is associated with the financial transaction request. Based on the fraud likelihood score and the transaction-specific trust profile, the transaction security engine 108 determines the transaction risk state for the digital payment transaction request.

In an embodiment, the transaction security engine 108 may be configured to select one or more mitigation actions from a plurality of security actions based on the determined transaction risk state. The one or more mitigation actions may include, but are not limited to, one or more of adaptive authentication enforcement, transaction throttling, privilege isolation, dynamic access restriction, transaction approval, and transaction rejection.

In an example scenario, the financial transaction request is received by the transaction security engine 108 and evaluated to determine a transaction risk state. Based on the determined transaction risk state, the transaction security engine 108 selects adaptive authentication enforcement and dynamic access restriction as mitigation actions. The transaction security engine 108 triggers re-authentication of the user entity and modifies access scopes associated with the transaction request. Upon completion of authentication and access verification, the transaction security engine 108 selects transaction approval as a subsequent mitigation action, allowing execution of the financial transaction request.

In an embodiment, the transaction security engine 108 may be configured to update one or more policy parameters based on the selected one or more mitigation actions to improve subsequent threat mitigation decisions for the cloud-based financial transactions. The one or more policy parameters may include state-to-action mapping parameters, threshold parameters, authentication control parameters, access control policy parameters, temporal parameters, update rule parameters, and the like.

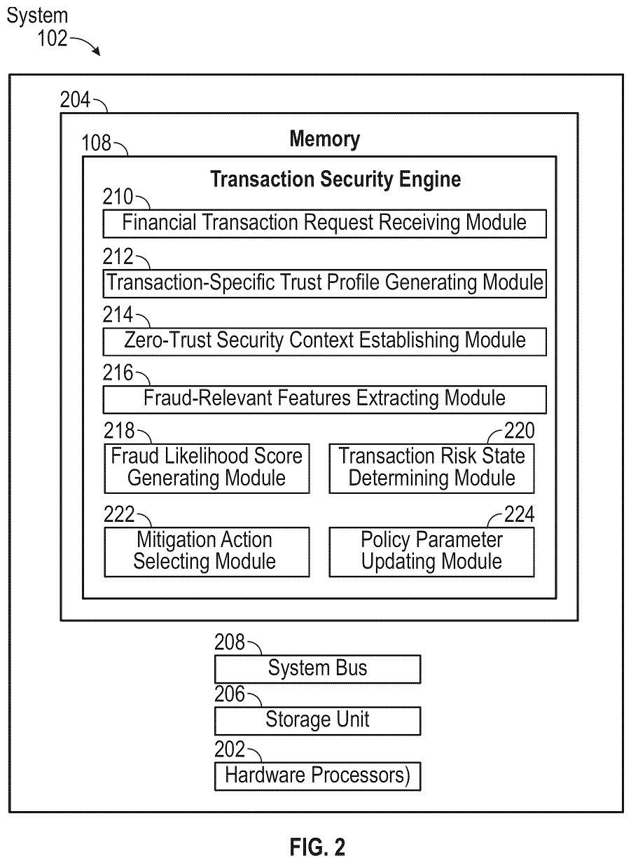

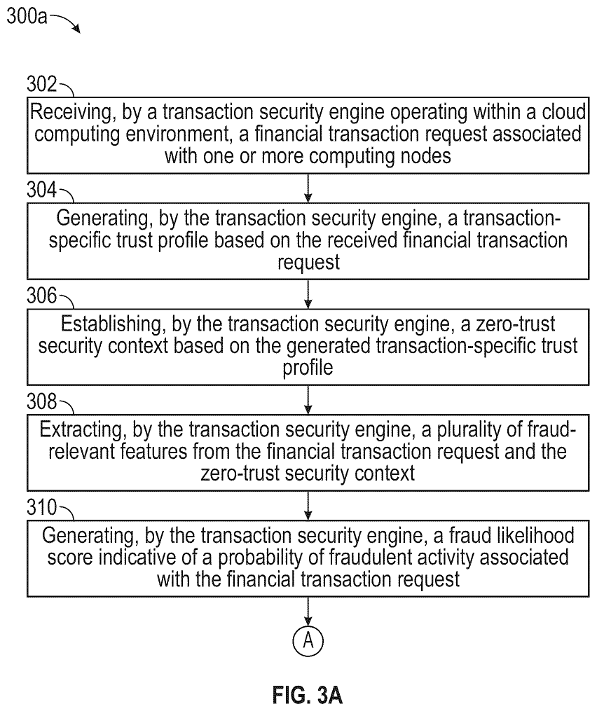

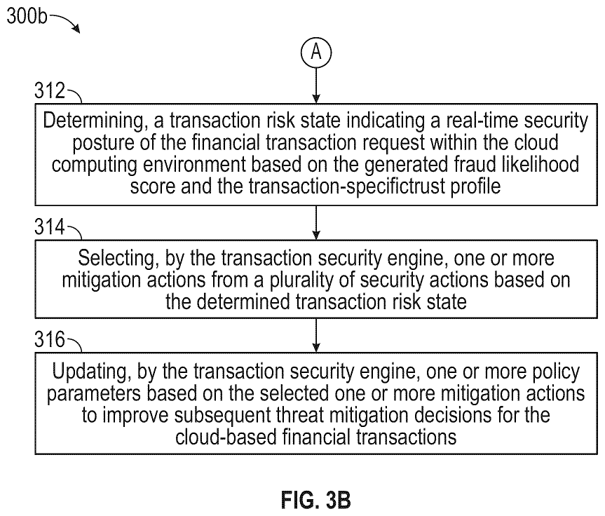

In an example scenario, following execution of the selected mitigation actions, the transaction security engine 108 updates the one or more policy parameters by modifying a threshold parameter associated with a fraud likelihood score range and updating a risk state-to-action mapping parameter stored in the policy data store. The updated policy parameters are made available for subsequent processing of future financial transaction requests. The transaction security engine 108 has been further detailed with reference to FIG. 2 and FIG. 3A and FIG. 3B.

FIG. 2 illustrates a block diagram 200 depicting the transaction security engine 108 for managing the cloud-based financial transactions within the cloud computing environment, in accordance with an embodiment of the present disclosure.

According to FIG. 2, the transaction security engine 108 may include one or more hardware processors 202, a memory 204 and a storage unit 206. The one or more hardware processors 202, the memory 204 and the storage unit 206 may be communicatively coupled through a system bus 208 or any similar mechanism. The memory 204 may include the transaction security engine 108 in the form of programmable instructions executable by the one or more hardware processors 202. Further, the transaction security engine 108 may include a financial transaction request receiving module 210, a transaction-specific trust profile generating module 212, a zero-trust security context establishing module 214, a fraud-relevant features extracting module 216, a fraud likelihood score generating module 218, a transaction risk state determining module 220, a mitigation action selecting module 222, and policy parameter updating module 224.

The financial transaction request receiving module 210 may be configured to receive the financial transaction request originating from the one or more computing nodes 104a, 104b, 104c . . . 104n within or external to a cloud computing environment. The financial transaction request receiving module 210 may be configured to parse the received financial transaction request to identify transaction-related data fields and forwards the request to subsequent modules of the transaction security engine for further processing. The financial transaction request receiving module 210 may also associate the received request with session identifiers, timestamps, or originating computing node identifiers for internal processing.

The transaction-specific trust profile generating module 212 may be configured to generate the transaction-specific trust profile for the received financial transaction request. The transaction-specific trust profile generating module 212 may be configured to process data extracted from the financial transaction request and contextual information associated with the one or more one or more computing nodes 104a, 104b, 104c . . . 104n to generate the structured trust profile. The generated transaction-specific trust profile may include trust-related attributes applicable only to the corresponding financial transaction request and is provided to other modules for establishing the zero-trust security context and determining the transaction risk state.

In an embodiment, the transaction-specific trust profile generating module 212 may be configured to compute a plurality of trust attributes based on the received financial transaction request. The plurality of trust attributes may include, but is not limited to, one or more device integrity parameters, one or more cryptographic session properties, one or more network path characteristics, and one or more historical access consistency metrics. Further, the transaction-specific trust profile generating module 212 may be configured to associate the plurality of trust attributes with the financial transaction request. The transaction-specific trust profile generating module 212 may be configured to generate the transaction-specific trust profile,

The zero-trust security context establishing module 214 may be configured to establish the zero-trust security context for the financial transaction request based on the generated transaction-specific trust profile. The zero-trust security context establishing module 214 may treat the financial transaction request, associated user entity, client device, and computing nodes as untrusted by default and applies continuous verification rules during transaction processing. The zero-trust security context may be maintained as a machine-readable context state and is updated or re-evaluated during execution of the transaction.

The fraud-relevant features extracting module 216 may be configured to extract the plurality of fraud-relevant features from the financial transaction request and the established zero-trust security context. The extracted features may include transaction parameters, behavioral indicators, contextual attributes, cryptographic validation states, and access control parameters. The extracted fraud-relevant features may be formatted into a feature set suitable for processing by the fraud likelihood score generating module 218.

In an embodiment, the fraud-relevant features extracting module 216 may be configured to derive behavioral deviation indicators by comparing current transaction interaction sequences with stored temporal interaction models corresponding to the user entity.

The behavioral deviation indicators may include machine-readable values representing deviations between a current transaction interaction sequence and the one or more stored temporal interaction models associated with the one or more computing nodes 104a, 104b, 104c . . . 104n.

The current transaction interaction sequence refers to an ordered set of interaction events generated during initiation and execution of a financial transaction request. The interaction events may include, but are not limited to, input actions, navigation steps, request timing intervals, authentication interactions, or transaction parameter modifications occurring during the transaction session.

The one or more temporal interaction models may include a structured representation of historical interaction sequences associated with the one or more computing nodes 104a, 104b, 104c . . . 104n. The one or more temporal interaction models may capture time-ordered relationships between interaction events and may be maintained as a sequence model, state-transition model, or time-indexed behavioral profile stored in a persistent data store.

Upon receiving a financial transaction request, the transaction security engine generates the current transaction interaction sequence by monitoring interaction events associated with the transaction session. The current transaction interaction sequence is provided to the fraud-relevant features extracting module.

The fraud-relevant features extracting module 216 may compare the current transaction interaction sequence with the retrieved temporal interaction models by aligning interaction event types, sequence ordering, and temporal spacing between events. The comparison may involve aligning current interaction events with expected event sequences defined in the temporal interaction model, measuring deviations in event ordering or presence, evaluating differences in time intervals between interaction events, and identifying interaction events not represented in the temporal interaction model.

The fraud likelihood score generating module 218 may be configured to process the extracted fraud-relevant features and generate the fraud likelihood score indicative of a probability of fraudulent activity associated with the financial transaction request. The fraud likelihood score generating module 218 may employ a fraud-detecting model to compute the fraud likelihood score as a numerical or categorical value. The generated fraud likelihood score may be associated with the financial transaction request and is forwarded to the transaction risk state determining module 220.

The transaction risk state determining module 220 may be configured to determine the transaction risk state based on the generated fraud likelihood score and the transaction-specific trust profile. The transaction risk state may represent a machine-readable representation of a current security posture of the financial transaction request within the cloud computing environment.

In an embodiment, the transaction risk state determining module 220 may be configured to map the fraud likelihood score and the transaction-specific trust profile to a discrete risk-state representation selected from a predefined set of risk states maintained in a transaction security state table based on the generated fraud likelihood score. Further, the transaction risk state determining module 220 may be configured to determine the transaction risk state based on the mapped fraud likelihood score and the transaction-specific trust profile.

The predefined set of risk states may be maintained in the transaction security state table, which includes structured entries defining associations between fraud likelihood score ranges, trust profile attributes, and corresponding risk-state identifiers. The transaction security state table is stored in a memory or database accessible to the transaction security engine 108. The transaction security state table may include a plurality of records. Each of the plurality of records may include one or more fraud likelihood score ranges or thresholds, one or more trust profile attribute conditions, and a corresponding discrete risk-state identifier.

In an example scenario, the transaction risk state determining module 220 accesses the transaction security state table and identifies a record corresponding to the fraud likelihood score range into which the generated fraud likelihood score falls. The module further evaluates the trust attributes in the transaction-specific trust profile against trust conditions defined in the same record.

Based on the mapping of the fraud likelihood score and the evaluation of the transaction-specific trust profile, the transaction risk state determining module 220 selects a discrete risk-state representation from the predefined set of risk states and assigns the selected risk-state representation as the transaction risk state for the financial transaction request.

The determined transaction risk state may be provided as input to the mitigation action selecting module 222. The mitigation action selecting module 222 may be configured to select the one or more mitigation actions from the predefined plurality of security actions based on the determined transaction risk state and applicable policy parameters. The selected mitigation actions may include authentication controls, access restrictions, transaction execution controls, approval, or rejection actions. The mitigation action selecting module 222 may be configured to generate mitigation action identifiers and execution parameters for application during transaction processing.

In an embodiment, the mitigation action selecting module 222 may be configured to apply a policy learned using an Artificial Intelligence (AI) model based on the determined transaction risk state. Further, the mitigation action selecting module 222 may be configured to select the one or more mitigation actions based on the applied policy learned.

The policy parameter updating module 224 may be configured to update the one or more policy parameters based on the selected mitigation actions and observed transaction execution records. The updated policy parameters may be stored in a persistent data store accessible to the transaction security engine 108. The policy parameter updating module 224 may be configured to make the updated policy parameters available for subsequent processing of future financial transaction requests.

In an embodiment, the policy parameter updating module 224 may be configured to store one or more records comprising the transaction risk state, the selected one or more mitigation actions, and a corresponding outcome in a database. Further, the policy parameter updating module 224 may be configured to retrain the AI model using the stored one or more records. The policy parameter updating module 224 may be configured to update the one or more policy parameters based on the retrained AI model.

FIG. 3A-FIG. 3B illustrates a flowchart depicting a method 300a-300b for managing cloud-based financial transactions executed by a transaction security system within a cloud computing environment, in accordance with an embodiment of the present disclosure.

Referring to FIG. 3A, at step 302, the method 300a may include receiving, by the transaction security engine operating within a cloud computing environment, a financial transaction request associated with one or more computing nodes.

At step 304, the method 300a may include generating, by the transaction security engine, a transaction-specific trust profile based on the received financial transaction request.

At step 306, the method 300a may include establishing, by the transaction security engine, the zero-trust security context based on the generated transaction-specific trust profile.

At step 308, the method 300a may include extracting, by the transaction security engine, a plurality of fraud-relevant features from the financial transaction request and the zero-trust security context.

At step 310, the method 300a may include generating, by the transaction security engine, a fraud likelihood score indicative of the probability of fraudulent activity associated with the financial transaction request.

Referring to FIG. 3B, at step 312, the method 300 may include determining, the transaction risk state indicating a real-time security posture of the financial transaction request within the cloud computing environment based on the generated fraud likelihood score and the transaction-specific trust profile.

At step 314, the method 300b may include selecting, by the transaction security engine, one or more mitigation actions from a plurality of security actions based on the determined transaction risk state.

At step 316, the method 300b may include updating, by the transaction security engine, the one or more policy parameters based on the selected one or more mitigation actions to improve subsequent threat mitigation decisions for the cloud-based financial transactions.

The method 300b may include the one or more mitigation actions comprises one or more of adaptive authentication enforcement, transaction throttling, privilege isolation, dynamic access restriction, transaction approval, and transaction rejection. The zero-trust security context may include the set of access control parameters, the one or more cryptographic validation states, the one or more continuous verification rules applied to the financial transaction request.

The plurality of fraud-relevant features may include the one or more of behavioral deviation indicators, the one or more contextual risk indicators, the one or more historical transaction correlations, and the one or more environmental anomaly signals.

In an embodiment, the method 300a-300b may include computing, by the transaction security engine, a plurality of trust attributes including one or more device integrity parameters, one or more cryptographic session properties, one or more network path characteristics, and one or more historical access consistency metrics. The method 300a-300b may include associating, by the transaction security engine, the plurality of trust attributes with the financial transaction request.

The method 300a-300b may include generating, by the transaction security engine, the transaction-specific trust profile. The transaction-specific trust profile comprises a structured set of trust attributes including the one or more device integrity parameters, the one or more cryptographic session properties, the one or more network path characteristics, and the one or more historical access consistency metrics associated with the financial transaction request.

The method 300a-300b may include extracting the plurality of fraud-relevant features comprises deriving behavioral deviation indicators by comparing current transaction interaction sequences with stored temporal interaction models corresponding to the user entity.

In an embodiment, the method 300a-300b may include mapping the fraud likelihood score and the transaction-specific trust profile to a discrete risk-state representation selected from a predefined set of risk states maintained in a transaction security state table based on the generated fraud likelihood score. The method 300a-300b may include determining, the transaction risk state based on the mapped fraud likelihood score and the transaction-specific trust profile.

In an embodiment, the method 300a-300b may include applying a policy learned using the Artificial Intelligence (AI) model based on the determined transaction risk state. The method 300a-300b may include selecting the one or more mitigation actions based on the applied policy learned.

In an embodiment, the method 300a-300b may include storing, by the transaction security engine, the one or more records comprising the transaction risk state, the selected one or more mitigation actions, and the corresponding outcome in the database. The method 300a-300b may include retraining, by the transaction security engine, an AI model using the stored one or more records. method 300a-300b may include updating, by the transaction security engine, the one or more policy parameters based on the retrained AI model.

The method 300a-300b may include operating at the cloud computing environment. Further, method 300a-300b may include transmitting the transaction-specific trust profile to the one or more computing nodes 104a, 104b, 104c . . . 104n operating within the cloud computing environment.

The methods may be implemented in any suitable hardware, software, firmware, or combination thereof.

In one practical implementation, the transaction security engine is deployed as a cloud-native security layer integrated with a financial transaction processing platform. The transaction security engine operates as an intermediary between transaction origination systems and cloud-hosted financial services.

In aforementioned implementation, financial transaction requests received from client devices or application servers are routed to the transaction security engine prior to execution. The transaction security engine performs transaction-specific trust profile generation, zero-trust security context establishment, fraud likelihood score generation, and transaction risk state determination. Based on the determined transaction risk state, mitigation actions are selected and applied before forwarding the transaction request to downstream services.

The transaction security engine maintains a transaction security state table and a policy parameter data store, both of which are accessible across multiple computing nodes within the cloud computing environment.

In another practical implementation, the transaction security engine is implemented as a set of distributed microservices, each corresponding to one or more functional modules, including fraud feature extraction, fraud likelihood score generation, risk state determination, and mitigation action selection.

Each microservice communicates with other microservices through internal service interfaces. The transaction-specific trust profile and transaction risk state are transmitted between microservices as machine-readable data objects. The policy parameter updating module updates policy parameters stored in a centralized database, which is referenced by the mitigation action selecting module during subsequent transaction processing.

In a further implementation, the transaction security engine operates across multiple cloud environments or a hybrid cloud configuration. Financial transaction requests originating in one cloud environment are processed using a transaction-specific trust profile that is transmitted to one or more cloud-resident security services operating in other cloud environments.

The transaction risk state determined for a transaction request is shared across cloud environments using standardized interfaces, enabling consistent mitigation action selection for transactions processed across distributed infrastructure.

The disclosed system and method may be practically implemented in a variety of cloud-based financial transaction processing environments. The implementations described below illustrate representative configurations of the transaction security engine and its interaction with cloud-resident components.

The following results illustrate observable system-level outcomes obtained during execution of the disclosed method in a controlled deployment environment. These results are provided for illustration only and do not limit the scope of the invention.

During execution of the disclosed method, financial transaction requests processed by the transaction security engine were classified into discrete transaction risk states maintained in the transaction security state table. Each transaction request was associated with exactly one discrete risk-state representation at a given processing stage, enabling deterministic downstream action selection.

Execution logs generated by the policy parameter updating module indicated that policy parameters were updated based on selected mitigation actions and corresponding transaction execution records. Updated policy parameters were persisted in the policy data store and referenced during subsequent transaction processing cycles.

In implementations where continuous verification rules were applied, the transaction risk state determining module re-evaluated transaction risk states when changes in transaction context were detected. Updated transaction risk states were recorded and transmitted to the mitigation action selecting module without restarting transaction processing.

In distributed and multi-cloud implementations, transaction-specific trust profiles and transaction risk states transmitted between computing nodes were consistently interpreted by cloud-resident security services, enabling uniform application of mitigation actions across distributed components.

Thus, various embodiments of the present invention provide a unified transaction security architecture that enables per-transaction trust evaluation within a cloud computing environment by generating transaction-specific trust profiles rather than relying on persistent or perimeter-based trust assumptions.

The invention introduces a structured mechanism for mapping fraud likelihood scores and transaction-specific trust profiles to discrete transaction risk states maintained in a transaction security state table, thereby enabling deterministic and machine-readable risk classification during transaction processing.

By integrating fraud-relevant feature extraction, fraud likelihood score generation, and transaction risk state determination within a single transaction security engine, the invention enables coordinated processing of transaction context, behavioral data, and cryptographic validation states without requiring external decision systems.

The use of discrete risk-state representations allows mitigation action selection to be decoupled from fraud detection logic, thereby enabling independent configuration and evolution of risk classification rules and mitigation policies within the cloud computing environment.

The invention supports continuous verification by applying access control parameters, cryptographic validation states, and verification rules throughout multiple stages of transaction execution, allowing transaction risk states to be re-evaluated as transaction context changes.

The modular architecture of the transaction security engine enables deployment across distributed computing nodes, microservices, or cloud-native environments, while maintaining consistent risk state determination and policy parameter management.

The policy parameter updating mechanism enables transaction execution records and selected mitigation actions to be incorporated into subsequent policy configurations, allowing systematic adjustment of policy parameters without modifying transaction processing logic.

The transaction-scoped design of trust profiles, fraud likelihood scores, and risk states reduces dependency on long-term user or device trust data and enables isolated evaluation of individual transaction instances within multi-tenant cloud infrastructures.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A method of managing cloud-based financial transactions executed by a transaction security system within a cloud computing environment, the method comprising:
receiving, by a transaction security engine operating within a cloud computing environment, a financial transaction request associated with one or more computing nodes;
generating, by the transaction security engine, a transaction-specific trust profile based on the received financial transaction request;
establishing, by the transaction security engine, a zero-trust security context based on the generated transaction-specific trust profile;
extracting, by the transaction security engine, a plurality of fraud-relevant features from the financial transaction request and the zero-trust security context;
generating, by the transaction security engine, a fraud likelihood score indicative of a probability of fraudulent activity associated with the financial transaction request;
determining, a transaction risk state indicating a real-time security posture of the financial transaction request within the cloud computing environment based on the generated fraud likelihood score and the transaction-specific trust profile;
selecting, by the transaction security engine, one or more mitigation actions from a plurality of security actions based on the determined transaction risk state; and
updating, by the transaction security engine, one or more policy parameters based on the selected one or more mitigation actions to improve subsequent threat mitigation decisions for the cloud-based financial transactions.

2. The method of claim 1, wherein the zero-trust security context comprises a set of access control parameters, one or more cryptographic validation states, one or more continuous verification rules applied to the financial transaction request.

3. The method of claim 1, wherein the one or more mitigation actions comprises one or more of adaptive authentication enforcement, transaction throttling, privilege isolation, dynamic access restriction, transaction approval, and transaction rejection.

4. The method of claim 1, wherein the plurality of fraud-relevant features comprises a plurality of behavioral deviation indicators, a plurality of contextual risk indicators, a plurality of historical transaction correlations, and a plurality of environmental anomaly signals.

5. The method of claim 1, wherein generating the transaction-specific trust profile comprises:
computing, by the transaction security engine, a plurality of trust attributes including one or more device integrity parameters, one or more cryptographic session properties, one or more network path characteristics, and one or more historical access consistency metrics based on the received financial transaction request;
associating, by the transaction security engine, the plurality of trust attributes with the financial transaction request; and
generating, by the transaction security engine, the transaction-specific trust profile, wherein the transaction-specific trust profile comprises a structured set of trust attributes including the one or more device integrity parameters, the one or more cryptographic session properties, the one or more network path characteristics, and the one or more historical access consistency metrics associated with the financial transaction request.

6. The method of claim 1, wherein extracting the plurality of fraud-relevant features comprises deriving behavioral deviation indicators by comparing current transaction interaction sequences with stored temporal interaction models corresponding to the user entity.

7. The method of claim 1, wherein determining the transaction risk state comprises:
mapping the fraud likelihood score and the transaction-specific trust profile to a discrete risk-state representation selected from a predefined set of risk states maintained in a transaction security state table based on the generated fraud likelihood score; and
determining, the transaction risk state based on the mapped fraud likelihood score and the transaction-specific trust profile.

8. The method of claim 1, wherein selecting the one or more mitigation actions comprises:
applying a policy learned using an Artificial Intelligence (AI) model based on the determined transaction risk state; and
selecting the one or more mitigation actions based on the applied policy learned.

9. The method of claim 1, wherein updating the one or more policy parameters comprises:
storing, by the transaction security engine, one or more records comprising the transaction risk state, the selected one or more mitigation actions, and a corresponding outcome in a database;
retraining, by the transaction security engine, an AI model using the stored one or more records; and
updating, by the transaction security engine, the one or more policy parameters based on the retrained AI model.

10. The method of claim 1, comprising:
transmitting, by the transaction security engine, the transaction-specific trust profile to the one or more computing nodes operating within the cloud computing environment.

11. A transaction security system for managing cloud-based financial transactions within a cloud computing environment, the transaction security system comprising:
a memory;
at least one processor is operatively coupled to the memory, wherein the at least one processor is configured to:
receive, using a transaction security engine operating within a cloud computing environment, a financial transaction request associated with one or more computing nodes;
generate, using the transaction security engine, a transaction-specific trust profile based on the received financial transaction request;
establish, using the transaction security engine, a zero-trust security context based on the generated transaction-specific trust profile;
extract, using the transaction security engine, a plurality of fraud-relevant features from the financial transaction request and the zero-trust security context;
generate, using the transaction security engine, a fraud likelihood score indicative of a probability of fraudulent activity associated with the financial transaction request;
determine, a transaction risk state indicating a real-time security posture of the financial transaction request within the cloud computing environment based on the generated fraud likelihood score and the transaction-specific trust profile;
select, by the transaction security engine, one or more mitigation actions from a plurality of security actions based on the determined transaction risk state; and
update, by the transaction security engine, one or more policy parameters based on the selected one or more mitigation actions to improve subsequent threat mitigation decisions for the cloud-based financial transactions.

12. The system of claim 11, wherein the one or more mitigation actions comprises one or more of adaptive authentication enforcement, transaction throttling, privilege isolation, dynamic access restriction, transaction approval, and transaction rejection.

13. The system of claim 11, wherein the plurality of fraud-relevant features comprises a plurality of behavioral deviation indicators, a plurality of contextual risk indicators, a plurality of historical transaction correlations, and a plurality of environmental anomaly signals.

14. The system of claim 11, wherein to generate the transaction-specific trust profile, the at least one processor is configured to:
compute, using the transaction security engine, a plurality of trust attributes including one or more device integrity parameters, one or more cryptographic session properties, one or more network path characteristics, and one or more historical access consistency metrics based on the received financial transaction request;
associate, using the transaction security engine, the plurality of trust attributes with the financial transaction request; and
generate, using the transaction security engine, the transaction-specific trust profile.

15. The system of claim 11, wherein to extract the plurality of fraud-relevant features, the at least one processor is configured to:
derive behavioral deviation indicators by comparing current transaction interaction sequences with stored temporal interaction models corresponding to the user entity.

16. The system of claim 11, wherein to determine the transaction risk state, the at least one processor is configured to:
map the fraud likelihood score and the transaction-specific trust profile to a discrete risk-state representation selected from a predefined set of risk states maintained in a transaction security state table based on the generated fraud likelihood score; and
determine, the transaction risk state based on the mapped fraud likelihood score and the transaction-specific trust profile.

17. The system of claim 11, wherein to select the one or more mitigation actions, the at least one processor is configured to:
apply a policy learned using an Artificial Intelligence (AI) model based on the determined transaction risk state; and
select the one or more mitigation actions based on the applied policy learned.

18. The system of claim 11, wherein to update the one or more policy parameters, the at least one processor is configured to:
store, using the transaction security engine, one or more records comprising the transaction risk state, the selected one or more mitigation actions, and a corresponding outcome in a database;
retrain, using the transaction security engine, an AI model using the stored one or more records; and
update, using the transaction security engine, the one or more policy parameters based on the retrained AI model.

19. The system of claim 11, wherein the transaction security system is configured to operate at the cloud computing environment, wherein the transaction-specific trust profile is transmitted to the one or more computing nodes operating within the cloud computing environment.

20. A non-transitory computer-readable medium storing instructions that, when executed, cause a processor to:
receive, using a transaction security engine operating within a cloud computing environment, a financial transaction request associated with one or more computing nodes;
generate, using the transaction security engine, a transaction-specific trust profile based on the received financial transaction request;
establish, using the transaction security engine, a zero-trust security context based on the generated transaction-specific trust profile;
extract, using the transaction security engine, a plurality of fraud-relevant features from the financial transaction request and the zero-trust security context;
generate, using the transaction security engine, a fraud likelihood score indicative of a probability of fraudulent activity associated with the financial transaction request;
determine, a transaction risk state indicating a real-time security posture of the financial transaction request within the cloud computing environment based on the generated fraud likelihood score and the transaction-specific trust profile;
select, by the transaction security engine, one or more mitigation actions from a plurality of security actions based on the determined transaction risk state; and
update, by the transaction security engine, one or more policy parameters based on the selected one or more mitigation actions to improve subsequent threat mitigation decisions for the cloud-based financial transactions.
